(19) United States
(12) Patent Application Publication
(10) Pub. No.: US 2009/0225348 A1
(43) Pub. Date: Sep. 10, 2009

(54) IMAGE FORMING APPARATUS GIVING NOTIFICATION OF ERROR IN APPARATUS TO DEVELOP USER AND SERVICE PERSON'S AWARENESS

(75) Inventors: Kouji Miyake, Nara (JP); Shuhji Fujii, Kyoto (JP); Kenji Takahashi, Nara (JP); Tsutomu Yoshimoto, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/397,681

(22) Filed: Mar. 4, 2009

(30) Foreign Application Priority Data
Mar. 7, 2008 (JP) 2008-058012

(51) Int. Cl. G06K 15/00

(52) U.S. Cl. 358/1.14

(57) ABSTRACT

When an error of an image forming apparatus is detected and power conduction is shut off with the error not rectified, information indicating occurrence of the error in the image forming apparatus is displayed on an electronic paper. Thus, an image forming apparatus that can notify the user and service person of the error and develop awareness about the error status of the apparatus even during the time of non-conduction can be provided.

### CROSS-REFERENCE TO RELATED APPLICATION

This nonprovisional application claims priority under 35 U.S.C. §119(a) on Patent Application No. 2008-058012 filed in Japan on Mar. 7, 2008, the entire contents of which are hereby incorporated by reference.

### BACKGROUND OF THE INVENTION

1. Field of the Invention

The present invention relates to an image forming apparatus having a function of detecting an error of the apparatus and displaying the state of error of the apparatus.

2. Description of the Background Art

Electronic paper is a thin display technology similar to a liquid crystal display and the like. The electronic paper is characterized in that it has similar appearance as ordinary paper, that displayed contents are electrically rewritable, and that power consumption thereof is very low as electric power is unnecessary to retain the displayed contents. Further, electronic paper is non-volatile, that is, once the displayed contents are rewritten, the displayed contents are maintained even when power is turned off. Attempts to apply electronic paper as such have been made in various technical fields.

By way of example, Japanese Patent Laying-Open No. 2003-209718 (hereinafter denoted as “'718 application”) proposes a technique of utilizing electronic paper in a digital camera. According to the technique disclosed in '718 application, when a power button is pressed by a user while the power is on, remaining battery level is calculated, and the maximum number of pictures that can be taken is calculated from available memory space. These pieces of calculated information are output to electronic paper, and on the electronic paper, information related to the remaining battery level and the maximum number of pictures that can be taken at present is displayed. Even when the power of digital camera is turned off thereafter, the displayed contents of information related to the remaining battery level and the maximum number of pictures that can be taken before power-off are maintained.

Further, Japanese Patent Laying-Open No. 2006-201460 (hereinafter denoted as “'460 application”) proposes a technique of utilizing electronic paper in an image forming apparatus such as a multifunctional printer. According to the technique disclosed in '460 application, information related to image formation, such as counter information and information of supplies, is displayed on electronic paper. This allows collection of necessary pieces of information without turning on the power.

Recent image forming apparatuses such as digital multifunctional printers have a function of detecting an error in the apparatus.

Such image forming apparatuses are classified to those in which power supply is shut off after the detection of error in the apparatus, and those in which the error state is kept as it is for a while after the detection of error, and then operation is changed to a standby mode with limited power consumption. In such situations, display on a display device provided on an operation unit is forced off. Therefore, it would be impossible to notify a user or a service person about what error has occurred in the apparatus.

In designing an image forming apparatus having the error detecting function as described above, it is a problem how to notify the user and service person and develop awareness about the cause of error, when the error occurred and power supply has been shut off accordingly.

Though it is possible by the techniques described in '718 and '460 applications to transmit necessary information to the user or service person even when power is off by displaying information before power off on the electronic paper, the idea described above cannot be realized. Specifically, the techniques described in '718 and '460 applications cannot directly be adopted to realize the idea described above.

### SUMMARY OF THE INVENTION

The present invention was made in view of the foregoing, and its object is to provide an image forming apparatus that can notify the user and service person and develop awareness about an error in the apparatus, even after power supply has been shut off subsequent to the error.

According to an aspect, the present invention provides an image forming apparatus, including: a first display unit displaying a state of the apparatus during the time of power conduction; a second display unit maintaining displayed contents during the time of non-power-conduction; an error detection unit detecting an error state of the apparatus; and an error display control circuit causing, when an error of the apparatus is detected by the error detection unit and power conduction to the apparatus is shut off with the error not rectified, the second display unit to display error information of the apparatus indicating occurrence of the error in the apparatus.

In the arrangement described above, the second display unit maintains the displayed contents even in a state of non-power-conduction. Therefore, even when operation of the apparatus is stopped, it is possible to continuously provide display to the user. Therefore, error of the apparatus can be confirmed before turning the power on. As a result, it becomes possible to prevent power-on of the apparatus by a general user, who is considered not skilled enough to rectify the error. On the other hand, it becomes unnecessary for a service person to turn the power on to confirm the error in the apparatus, and hence, service period can be reduced.

Examples of “error in the apparatus” may include toner empty, stapler empty, change photoreceptor drum, change developer, need maintenance, waste toner full, paper empty, unsuccessful fixing, defect in optical system, hard disk error and LCC error.

Preferably, the second display unit is a non-volatile display device.

In the arrangement above, even when the second display unit is in a non-power-conduction state, displayed contents thereof can be maintained and, therefore, even when operation of the apparatus is suspended, display to the user can be maintained continuously. Therefore, necessary message can be delivered to the user without wasting power.

An example of the “non-volatile display device” may include electronic paper.

More preferably, the second display unit also serves as the first display unit.

This enables display both during the time of power conduction and during the time of non-power-conduction without increasing cost of the apparatus, and it is unnecessary for the user to see a plurality of displays. Therefore, interface with the user is not degraded.

More preferably, the error display control circuit causes the second display unit to display, as the error information of the apparatus, information indicating occurrence of paper jam.

More preferably, the error display control circuit causes the second display unit to display, as the error information of the apparatus, information indicating shortage of supplies related to image formation.

More preferably, the error display control circuit causes the second display unit to display, as the error information of the apparatus, information urging contact with a service person.

By such arrangement, even when an error causing damage to the apparatus and the user such as an error in temperature control of a fixing device occurs, appropriate maintenance is possible without causing further damage by power conduction, as the state of error of the apparatus can be notified when power is not supplied, as described above.

More preferably, the information urging contact with a service person is either the information indicating occurrence of a trouble in the apparatus or the information indicating end of life of a consumable part.

More preferably, the error display control circuit includes a display control circuit causing, when the error information of the apparatus is displayed on the second display unit, display of information to avoid the error of the apparatus, in addition to the error information of the apparatus.

In the arrangement above, a method of avoiding error of the apparatus, such as an indication of a position where jam occurred or a message urging exchange of photoreceptor drum, is displayed on the second display unit. Therefore, error can be avoided without supplying wasteful power.

More preferably, the error display control circuit includes a display control circuit causing, when the error information of the apparatus is displayed on the second display unit, the error information of the apparatus to be displayed in an enhanced manner that better appeals to the user.

Then, it is possible for the user to understand, by simply taking one look at the contents displayed on the second display unit, which type of error occurred in the apparatus.

Examples of the manner of “emphasized display” may include display of the paper empty portion or the like in highlight or in enlargement, or elimination of other displays unrelated to the error of the apparatus and to leave only the display of error information of the apparatus.

More preferably, the error display control circuit includes a display control circuit causing the second display unit to display, when a plurality of errors are detected by the error detection unit, pieces of error information of the apparatus successively, starting from one having highest priority.

Then, it is possible for the user and the service person to check the errors of the apparatus starting from the one having higher priority.

More preferably, the error display control circuit includes a display control circuit causing the second display unit to continue display of the error information of the apparatus even after power conduction to the apparatus is resumed.

Then, error information of the apparatus continuously displayed on the second display unit when power conduction is resumed provides good support for the user and the service person.

According to the present invention, even when power supply to the apparatus is shut off subsequent to an error occurred in the apparatus, the state of the apparatus before shut-off can be displayed. Therefore, an image forming apparatus that can give notification of error to the user and service person to develop awareness about the state of error in the apparatus and the like even in the non-conduction state can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an outer appearance of an image forming apparatus in accordance with a first embodiment of the present invention.

FIG. 2 schematically shows an internal configuration of the image forming apparatus in accordance with a first embodiment.

FIG. 3 is a block diagram showing hardware configuration of the image forming apparatus in accordance with the first embodiment.

FIG. 4 is a plan view showing an appearance of an operating unit.

FIG. 5 shows, in the form of a flowchart, a structure of an error display control program of the image forming apparatus in accordance with the first embodiment.

FIG. 6 shows an initial image of the image forming apparatus displayed on electronic paper.

FIG. 7 shows an example of a display of an error state on an electronic paper, when the error is detected by an error detection sensor in an image forming unit.

FIG. 8 shows an example of a display on the electronic paper, showing an image indicating an error state of the apparatus different from that of FIG. 7.

FIG. 9 shows an example of a display on the electronic paper, showing an image indicating an error state of the apparatus different from those of FIGS. 7 and 8.

FIG. 10 shows an example of a display on the electronic paper, showing an image indicating an error state of the apparatus different from those of FIGS. 7 to 9.

FIG. 11 is a perspective view showing an outer appearance of an image forming apparatus in accordance with a second embodiment of the present invention.

FIG. 12 is a block diagram showing hardware configuration of the image forming apparatus in accordance with the second embodiment.

FIG. 13 is a plan view showing an appearance of an operating unit.

FIG. 14 shows, in the form of a flowchart, a structure of an error display control program of the image forming apparatus in accordance with the second embodiment.

FIG. 15 shows an example in which a message “TONER LOW” is highlighted and made larger than in FIG. 8.

FIG. 16 shows an example in which a message “TONER LOW” is enlarged and displayed overlapped on the standard image of FIG. 6.

FIG. 17 shows an example in which a message “TONER LOW” is enlarged and displayed highlighted and overlapped on the standard image of FIG. 6.

FIG. 18 shows an example in which a message “TONER LOW” is enlarged and displayed while other displays are eliminated.

FIG. 19 shows an example in which a message “PAPER EMPTY” of FIG. 7 is displayed in enlargement.

### DESCRIPTION OF THE PREFERRED EMBODIMENTS

In the following description and in the drawings, the same components are denoted by the same reference characters. Their names and functions are also the same. Therefore, detailed description thereof will not be repeated.

### First Embodiment

<Overall Configuration of Image Forming Apparatus 20>

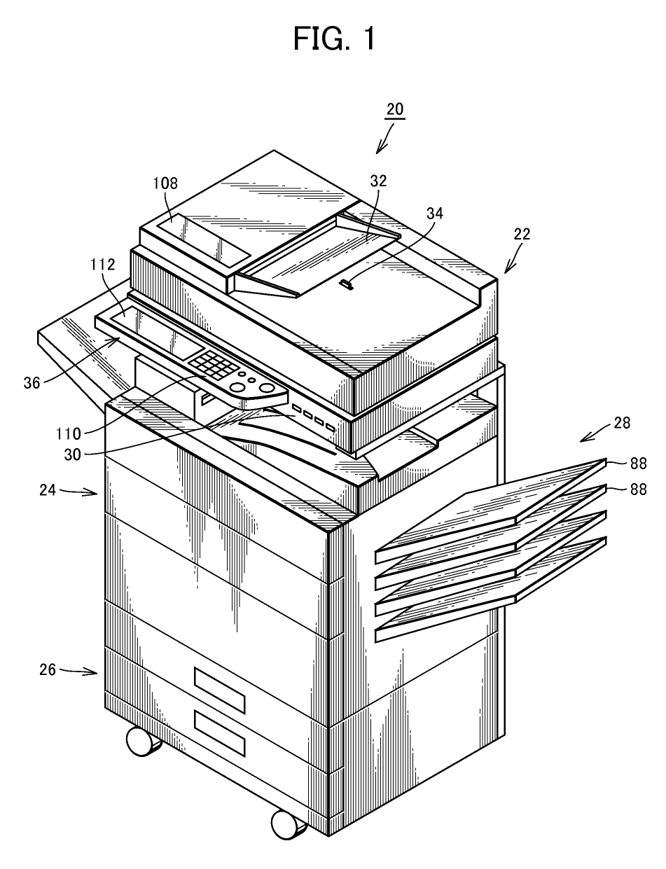

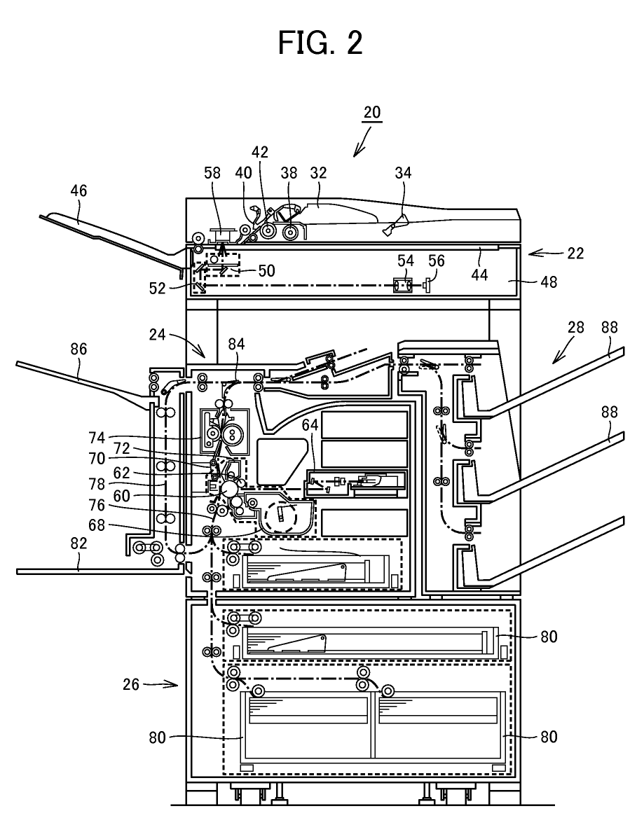

Referring to FIGS. 1 and 2, an image forming apparatus 20 in accordance with the present embodiment is a digital multifunctional printer. Image forming apparatus 20 is capable of operating selectively in, for example, a copy mode in which an image of a document is read and printed on a sheet of printing paper, a facsimile mode in which an image of a document is read and transmitted and an image of a document is received and printed on a sheet of printing paper, and a printer mode in which an image received through a network from an information terminal, not shown, is printed on a sheet of printing paper.

Image forming apparatus 20 includes a document feeding and reading unit 22, an image forming unit 24, a paper feeding unit 26, a post processing device 28, and a USB (Universal Serial Bus) interface 30.

Internal configuration of image forming apparatus 20 will be described taking an operation in the copy mode as an example.

When a user sets a document on a document set tray 32 of document feeding and reading unit 22, a document detection sensor 34 detects that the document has been set. The user operates operating unit 36 of document feeding and reading unit 22, to input and set size of printing paper, magnification and the like. After the input and setting, an instruction to start copying is given in accordance with the contents of operation on operating unit 36.

In response to an operation of operating unit 36, document feeding and reading unit 22 draws the document on document set tray 32 one by one, by pick-up roller 38. Document feeding and reading unit 22 feeds the drawn document to a platen glass 44 through a separation plate 40 and a feed roller 42, feeds the document in a sub-scanning direction on platen glass 44, and discharges the document to a document discharge tray 46.

At this time, a surface (lower surface) of the document is read by a first reading unit 48. Specifically, the first reading unit 48 first moves and positions a first scanning unit 50 to a prescribed position, and positions a second scanning unit 52 at a prescribed position. Thereafter, the first reading unit 48 irradiates the document surface through platen glass 44 with an exposure lamp of first scanning unit 50, and guides light reflected from the document to an imaging lens 54 through reflection mirrors of first and second scanning units 50 and 52. The light reflected from the document is collected by imaging lens 54 to a CCD (Charge Coupled Device) 56, and the image on the document surface is formed on CCD 56, whereby the image on the document surface is read.

Further, a rear surface (upper surface) of the document is read by the second reading unit 58. The second reading unit 58 is arranged above platen glass 44. The second reading unit 58 includes an exposure lamp, formed of an LED (Light Emitting Diode) array, a fluorescent lamp and the like, irradiating the rear surface of document, a SELFOC (registered trademark) lens array collecting light reflected from the document pixel by pixel, and a contact image sensor (CIS) performing photo-electric conversion of the light reflected from the document received through SELFOC lens array and outputting an analog image signal.

When the user opens an upper part of document feeding and reading unit 22 and places a document on platen glass 44, the first reading unit 48 can read the document surface in this state. In this case, the first reading unit 48 moves the first and second scanning units 50 and 52 in the sub-scanning direction while maintaining a prescribed speed relation to each other, whereby the document on platen glass 44 is exposed by the first scanning unit 50 and the light reflected from the document is guided by the first and second scanning units 50 and 52 to imaging lens 54. The document image is formed on CCD 56 by the imaging lens 54.

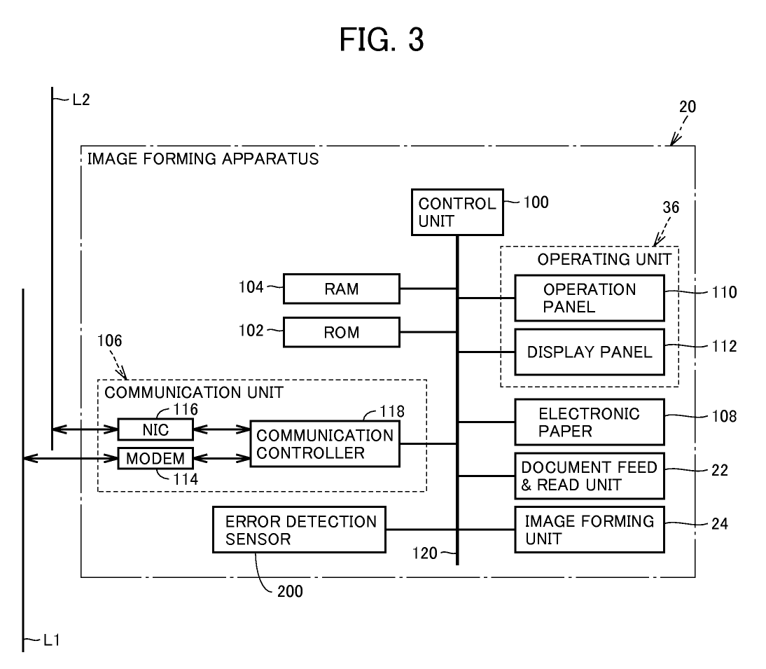

When image or images on one or both surfaces of the document are read in the above-described manner, image data representing the image or images on one or both surfaces of the document is input to a control unit 100 implemented, for example, by a micro-computer shown in FIG. 3. In control unit 100, the image data is subjected to various types of image processing and output to image forming unit 24.

Image forming unit 24 prints the document image on a sheet of recording paper based on the image data. Image forming unit 24 includes a photoreceptor drum 60, a charger 62, a laser scanning unit (hereinafter denoted as “LSU”) 64, a developer 68, a transfer device 70, a cleaning device 72, a fixing device 74, a neutralizer, not shown, and the like.

Further, image forming unit 24 is provided with a main feeding path 76 and a reverse feeding path 78. A sheet of recording paper fed from paper feeding unit 26 is fed along main feeding path 76. Paper feeding unit 26 draws sheets of recording paper contained in paper cassette 80 or placed on a manual feed tray 82 one by one, and feeds the drawn sheet of recording paper to main feeding path 76 of image forming unit 24.

While the sheet of paper is fed along main feeding path 76 of image forming unit 24, that is, while the sheet of paper passes between photoreceptor drum 60 and transfer device 70 and further through fixing device 74, printing is done on the sheet of recording paper.

Photoreceptor drum 60 rotates in one direction. The surface of photoreceptor drum 60 is cleaned by cleaning device 72 and the neutralizer, and then uniformly charged by charger 62.

LSU 64 modulates laser beam based on the image data output from document feeding and reading unit 22, and repeatedly scans the surface of photoreceptor drum 60 with the laser beam in the main scanning direction, whereby an electrostatic latent image is formed on the surface of photoreceptor drum 60.

Developer 68 develops the electrostatic latent image by supplying toner to the surface of photoreceptor drum 60, and forms a toner image on the surface of photoreceptor drum 60.

Transfer device 70 transfers the toner image on the surface of photoreceptor drum 60, to the sheet of recording paper passing through transfer device 70 and photoreceptor drum 60.

Fixing device 74 fixes the toner image on the sheet of recording paper, by applying heat and pressure to the sheet of recording paper.

At a connecting position between main feeding path 76 and reverse feeding path 78, a branching pawl 84 is provided. When printing is to be done only on one side of the sheet of recording paper, branching pawl 84 is positioned such that the sheet of recording paper fed from fixing device 74 is guided by branching pawl 84 to discharge tray 86 or to a post processing device 28.

When printing is to be done on both surfaces of the sheet of recording paper, branching pawl 84 is turned in a prescribed direction so that the sheet of recording paper is guided to reverse feeding path 78. The sheet of recording paper is turned over as it passes through reverse feeding path 78, and then it is again fed to the main feeding path 76. Thereafter, as the sheet of recording paper is again fed along the main feeding path 76, printing is done on the rear surface, and the sheet is guided to discharge tray 86 or post processing device 28.

The sheet of recording paper on which printing has been done as described above is guided to discharge tray 86 or post processing device 28, and discharged to discharge tray 86 or to any of discharge trays 88 of post processing device 28.

Post processing device 28 is for performing processes of sorting and discharging a plurality of sheets of recording paper to discharge trays 88, punching each sheet of recording paper, and stapling the sheets of paper. By way of example, when a number of printed copies are to be prepared, post processing device 28 sorts and discharges sheets of recording paper to discharge trays 88 such that sorted sets of copies are allotted one by one, and each set of sheets on each discharge tray 88 is punched or stapled, whereby printed copies are provided.

<Hardware Configuration of Image Forming Apparatus 20>

Referring to FIG. 3, image forming apparatus 20 includes document feeding and reading unit 22 capable of reading document image, image forming unit 24 providing printed output by forming an image read by document feeding and reading unit 22 on a sheet of paper with the image color reproduced by electro-photographic process, operating unit 36 allowing settings of various functions related to the image forming process, and, in addition, a control unit 100, an ROM (Read Only Memory) 102, an RAM (Random Access Memory) 104, a communication unit 106, an electronic paper 108, and an error detection sensor 200.

Operating unit 36 includes an operation panel 110 and a display panel 112. Appearances of operation panel 110 and display panel 112 will be described later.

Control unit 100 is in charge of overall control of image forming apparatus 20. Control unit 100 is implemented by a CPU (Central Processing Unit) or the like.

ROM 102 stores a program, data and the like necessary for controlling an operation of image forming apparatus 20. Control unit 100 controls image forming apparatus 20 in accordance with the program and data stored in ROM 102, and executes control related to various functions of image forming apparatus 20.

RAM 104 has a function of a working memory temporarily storing results of operations and processes performed by control unit 100, a function of a back-up memory storing count value, jam and service error history information, information of supplies and the like and a function of a frame memory storing image data.

Communication unit 106 includes a modem 114, an NIC (Network Interface Card) 116 and a communication controller 118. Modem 114 provides an interface with telephone line L1 connected to a facsimile device, not shown. NIC 116 provides an interface with an LAN (Local Area Network) line L2 connected to an information terminal such as a computer, not shown. Communication controller 118 controls operations of modem 114 and NIC 116.

Electronic paper 108 is a non-volatile display member, and contents displayed thereon can be maintained continuously even when power supply to display panel 112 is stopped. Specifically, electronic paper 108 serves as an auxiliary display unit to display panel 112. As shown in FIG. 1, electronic paper 108 is attached to a top plate of document feeding and reading unit 22.

Error detection sensor 200 is for detecting any error of image forming apparatus 20. Error detection sensors 200 are provided at document feeding and reading unit 22, image forming unit 24, main feeding path 76, reverse feeding path 78 and so on.

Document feeding and reading unit 22, image forming unit 24, ROM 102, RAM 104, operation panel 110 and display panel 112 of operating unit 36, communication controller 118 of communication unit 106, electronic paper 108 and error detection sensor 200 described above are connected to a bus 120 extending from control unit 100. Therefore, document feeding and reading unit 22, image forming unit 24, ROM 102, RAM 104, operation panel 110 and display panel 112 of operating unit 36, communication controller 118 of communication unit 106, electronic paper 108 and error detection sensor 200 are controlled by control unit 100.

Particularly, in the present embodiment, control unit 100 performs power conduction control using a driving power source, not shown, on document feeding and reading unit 22, image forming unit 24, operating unit 36, communication unit 106 and electronic paper 108 described above, at the time of transition from normal operation mode to standby mode in which power consumption is limited, and from standby mode to normal operation mode.

Further, control unit 100 and communication controller 118 of communication unit 106 form display data based on data stored in RAM 104 and the like, respectively, and control electronic paper 108 such that the display data is displayed thereon.

<Appearance of Operating Unit 36>

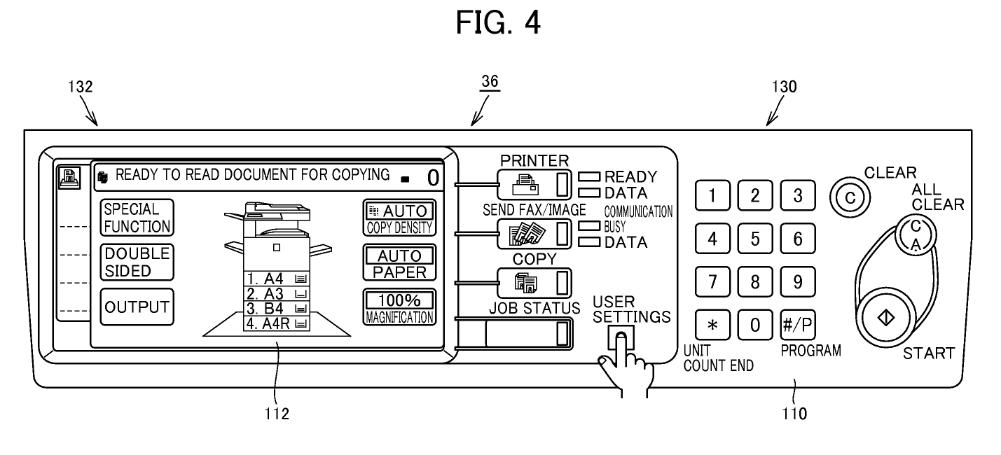

Referring to FIG. 4, operating unit 36 is formed by integrating operation panel 110 and display panel 112. Operating unit 36 is divided into two areas 130 and 132.

Specifically, operation panel 110 is placed on the right area 130 of operating unit 36. On operation panel 110, ten keys and various other operation buttons are provided. On the other hand, display panel 112 is arranged from the center to the left area 132 of operating unit 36. Display panel 112 is formed of a small, touch-panel integrated type liquid crystal display.

The user can confirm the state of image forming apparatus 20, job processing status, and the like, by looking at the display on display panel 112 of operating unit 36. Further, it is possible for the user to set functions and to instruct an operation of image forming apparatus 20 and the like, by selecting, on the touch panel superposed on the display area, a select button displayed on the display area of liquid crystal display of display panel 112.

<Software Configuration>

In the present embodiment, a program stored in ROM 102 is programmed such that, when an error occurs in image forming apparatus 20 and power supply to image forming apparatus 20 is shut off, the state of error of image forming apparatus 20 is displayed on electronic paper 108.

The program realizes the following function of image forming apparatus 20. The function is realized by control unit 100 including a CPU executing the program mentioned above.

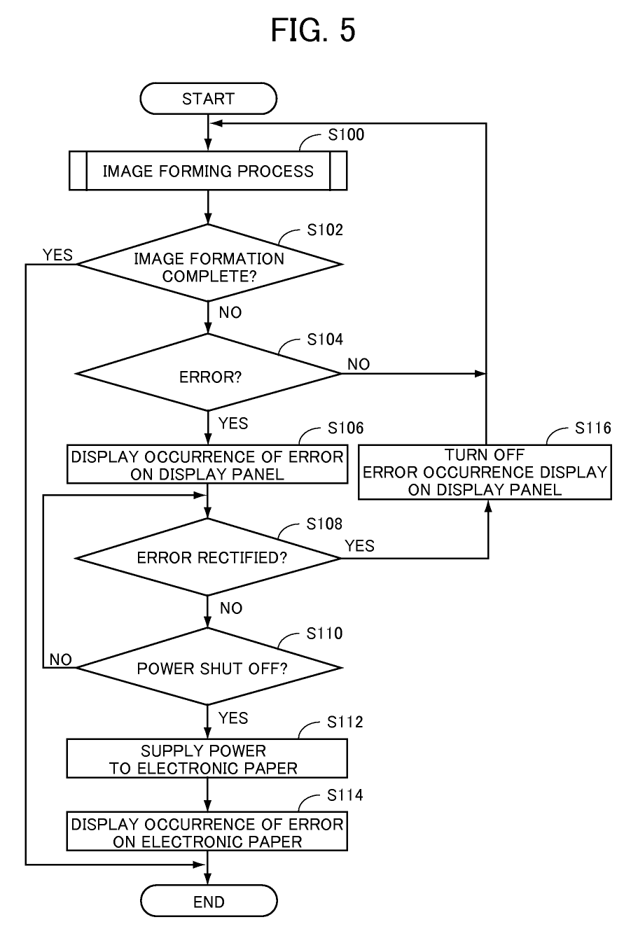

Referring to FIG. 5, by way of example, when the user presses a start key on operation panel 110, control unit 100 causes image forming unit 24 to perform an image forming process and determines whether the image forming process has been completed or not (steps 100 and 102).

Based on an output signal from error detection sensor 200, if it is determined that an error has occurred in image forming apparatus 20 before the completion of image forming process (YES at step 104), control unit 100 displays information to that effect on display panel 112, and determines whether the error has been rectified or not (steps 106 and 108).

If the error of image forming apparatus 20 has been rectified (YES at step 108), control unit 100 turns off the error occurrence display on display panel 112 (step 116). Thereafter, control unit 100 returns the flow to step 100, and the image forming process by image forming unit 24 is continued.

If the error of image forming apparatus 20 is not rectified (NO at step 108), control unit 100 determines whether or not power supply to image forming apparatus 20 is turned off by the user (step 110).

If power supply is stopped by the user (YES at step 110), control unit 100 supplies power to electronic paper 108, and causes electronic paper 108 to display occurrence of error of the image forming apparatus 20 (steps 112 and 114). The displayed contents are kept even after power supply to electronic paper 108 is stopped thereafter.

<Operation>

If an error of image forming apparatus 20, such as toner empty, stapler empty, change photoreceptor drum, change developer, need maintenance, waste toner full, paper empty (including size and location), unsuccessful fixing, defect in optical system, hard disk error and LCC error is detected by error detection sensor 200, a corresponding message is displayed on display panel 112, giving alarm about the status to the user.

If power supply to image forming apparatus 20 is shut off by the user while the error of image forming apparatus 20 such as mentioned above is not rectified, power is supplied to electronic paper 108 before power supply voltage fully decreases.

Because of the supplied power, media particles forming the surface of electronic paper 108 move physically (electrophoresis), whereby various pieces of error information mentioned above are displayed on electronic paper 108.

Even when the power supply to electronic paper 108 is stopped, the moved particles (that went under electrophoresis) remain in that state. As a result, displayed contents on electronic paper 108 can be maintained.

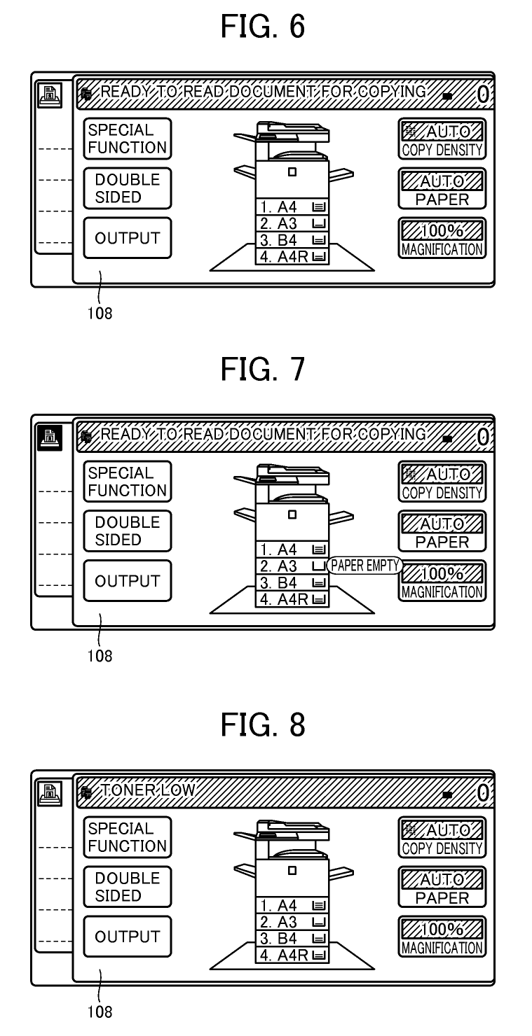

FIG. 6 shows an initial image of electronic paper 108 of FIG. 4. This image allows execution of copying function.

FIG. 7 shows an exemplary display on electronic paper 108 of an error state that is displayed when an error in image forming unit 24 is detected by error detection sensor 200.

In the example described above, when an error of image forming apparatus 20 is detected by error detection sensor 200, operation of image forming apparatus 20 is stopped. When an error occurs in image forming apparatus 20, it is possible to stop an operation of a part of image forming apparatus 20 or to stop an operation of image forming apparatus 20 as a whole. The error alarm shown in FIG. 7 is “PAPER EMPTY OF ‘2.A3 SIZE’ PAPER CASSETTE”, which is a minor error that paper cannot be fed from this paper cassette. Therefore, only the operation of corresponding paper cassette is stopped and other operations are allowed. As to the manner of display, the inside of paper cassette in the illustration of image forming apparatus 20 displayed at the central portion of electronic paper 108 is shown empty and, text message of “PAPER EMPTY” is additionally displayed in a balloon.

FIG. 8 shows an image indicating an error different from the example above. Here, a message “TONER LOW” is displayed. When this display is given, it is determined by control unit 100 that the error is serious as satisfactory image formation is impossible because of toner shortage and, therefore, the operation of image forming unit 24 as a whole is stopped.

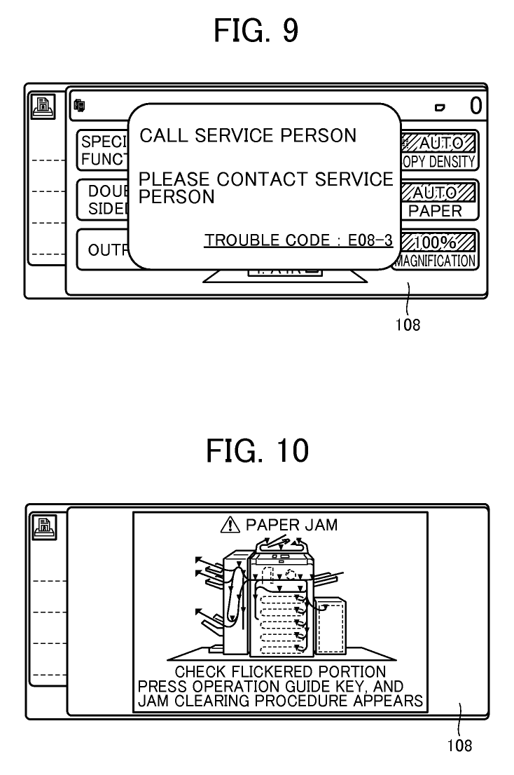

FIG. 9 shows an image indicating an error different from the examples above. Here, a message of “CALL SERVICE PERSON” and, in addition, “TROUBLE CODE: E08-3” are displayed, allowing recognition of error state on electronic paper 108. The message “CALL SERVICE PERSON” appears when the trouble is out of control by a general user, in order to prevent the user from inadvertently trying to tackle the problem. As the trouble code is displayed, the user cannot identify the position of error in image forming apparatus 20. The message “CALL SERVICE PERSON” is displayed enlarged and overlapped on the initial image shown in FIG. 6.

FIG. 10 shows an image indicating an error different from the examples above. Here, a message of “PAPER JAM” is displayed and, in addition, a mark of “black triangle facing downward” is displayed on the illustration of image forming apparatus 20 to identify the position where paper jammed. With this display, the operation of image forming unit 24 stops. When this display is given, other displays are turned off.

In this manner, as the displays shown in FIGS. 6 to 10 are displayed on electronic paper 108, even when power supply to image forming apparatus 20 as a whole is stopped, the error state of image forming apparatus 20 can be notified to the user because of the non-volatile display function of electronic paper 108.

Typical error states of image forming apparatus 20 have been described with reference to FIG. 6 to 10 above. It is noted that, when such an error occurs (YES at step 104 of FIG. 5) and the user stops power supply without providing appropriate maintenance, or when the power supply is not stopped but the state is kept for a long period of time and operation of image forming apparatus 20 is changed to the standby mode of limited power consumption, power conduction to display panel 112 and main components of image forming unit 24 is shut off.

<Functions/Effects>

The present embodiment provides the following functions/effects.

When power conduction is shut off because of an error of image forming apparatus 20, the state of image forming apparatus 20 before shut-off can be displayed on electronic paper 108. Therefore, it is possible to notify the user and the service person of the error and to develop awareness about the state of error in the image forming apparatus 20 and the like even in the non-conduction state. Therefore, error of the apparatus can be confirmed before turning the power on. As a result, it becomes possible to prevent power-on of the apparatus by a general user, who is considered not skilled enough to rectify the error. On the other hand, it becomes unnecessary for a service person to turn the power on to confirm the error in the apparatus, and hence, service period can be reduced.

As described above, Electronic paper 108 can maintain displayed contents even when power is not supplied and, therefore, display for the user can be continuously given to the user even if operation of image forming apparatus 20 is suspended. Therefore, a message necessary for the user can be given to the user without wasting power.

Further, the error information of image forming apparatus 20 displayed on electronic paper 108 includes information urging contact with a service person (CALL SERVICE PERSON). Therefore, even when an error causing damage to the image forming apparatus 20 and the user such as an error in temperature control of a fixing device occurs, appropriate maintenance is possible without causing further damage by power conduction, as the state of error of image forming apparatus 20 can be notified when power is not supplied, as described above.

Further, when error information of image forming apparatus 20 is displayed on electronic paper 108, an information of avoiding error of image forming apparatus 20 is additionally displayed. Therefore, error can be avoided without supplying wasteful power.

### Second Embodiment

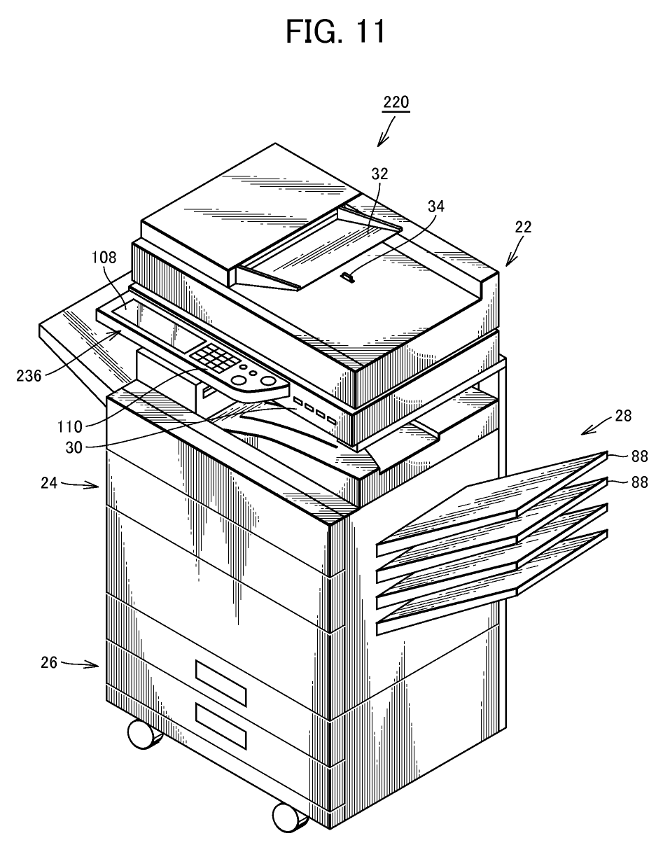

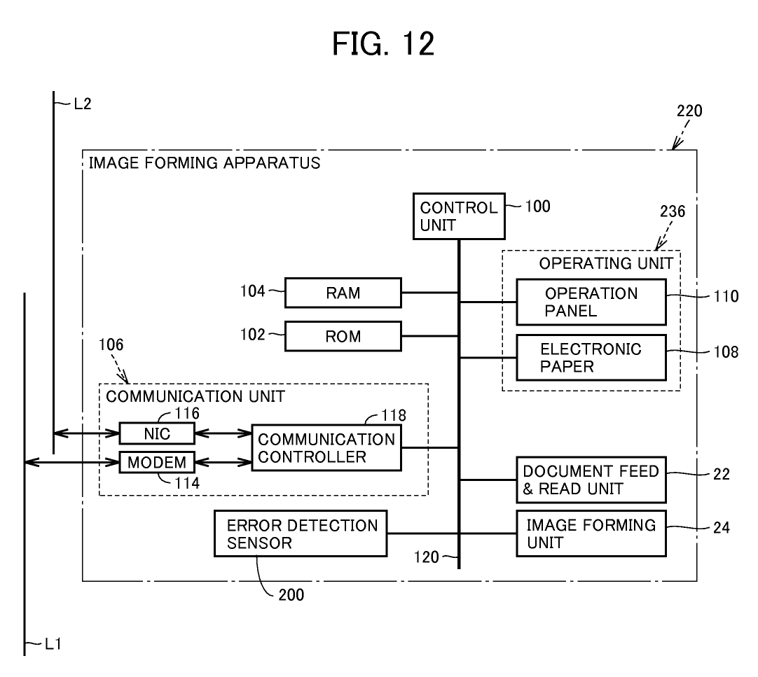

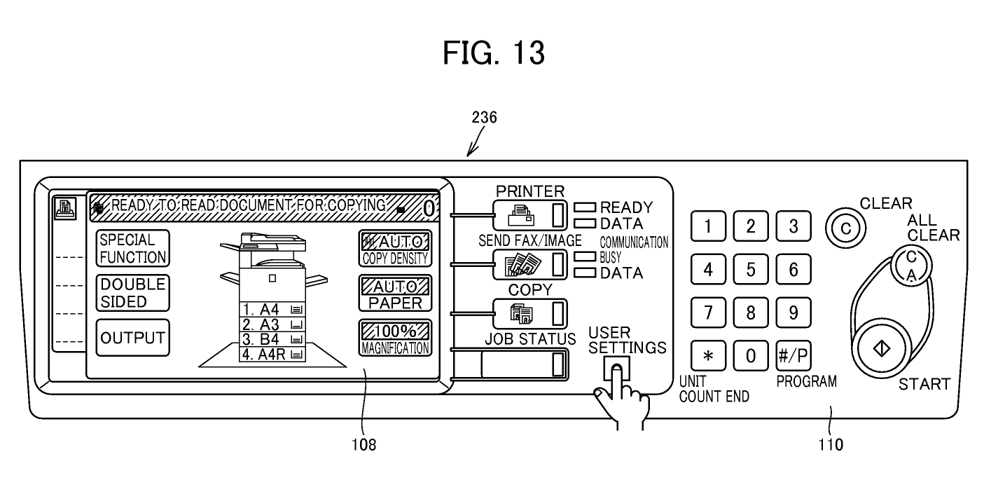

Referring to FIGS. 11 to 13, an image forming apparatus 220 in accordance with the second embodiment is characterized in that an operating unit 236 with electronic paper 108 is provided in place of operating unit 36 with display panel 112 so that electronic paper 108 also serves as display panel 112 of operating unit 36. Except for this point, the configuration is the same as that of the first embodiment.

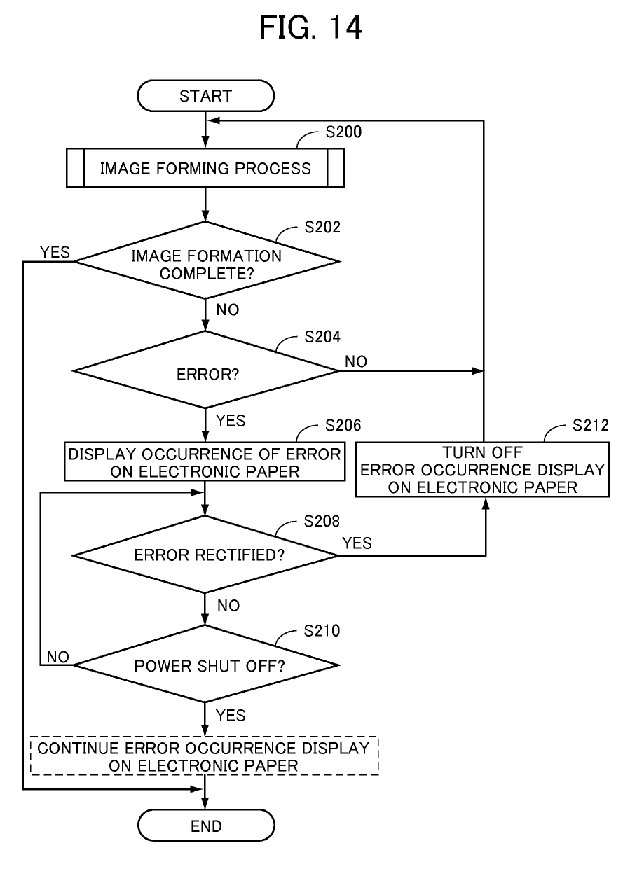

An operation of image forming apparatus 220 will be described with reference to the flowchart of FIG. 14.

Referring to FIG. 14, by way of example, when a start key on operation panel 110 is pressed, control unit 100 causes image forming unit 24 to perform an image forming process and determines whether the image forming process has been completed or not (steps 200 and 202).

Based on an output signal from error detection sensor 200, if it is determined that an error has occurred in image forming apparatus 220 before the completion of image forming process (YES at step 204), control unit 100 displays information to that effect on electronic paper 108, and determines whether the error has been rectified or not (steps 206 and 208).

If the error of image forming apparatus 220 has been rectified (YES at step 208), control unit 100 turns off the error occurrence display on electronic paper 108 (step 212). Thereafter, control unit 100 returns the flow to step 200, and the image forming process by image forming unit 24 is continued.

If the error of image forming apparatus 220 is not rectified (NO at step 208) and power supply to image forming apparatus 220 is shut off by the user (YES at step 210), the display of error occurrence on electronic paper 108 is continued.

<Functions/Effects>

The present embodiment attains functions/effects similar to those attained by the first embodiment, and additionally attains the following function and effect.

Electronic paper 108 functions as a display unit of operating unit 236. This enables display both during the time of power conduction and during the time of non-power-conduction without increasing cost of the apparatus, and it is unnecessary for the user to see a plurality of displays. Therefore, interface with the user is not degraded.

The present invention is not limited to the embodiments described above.

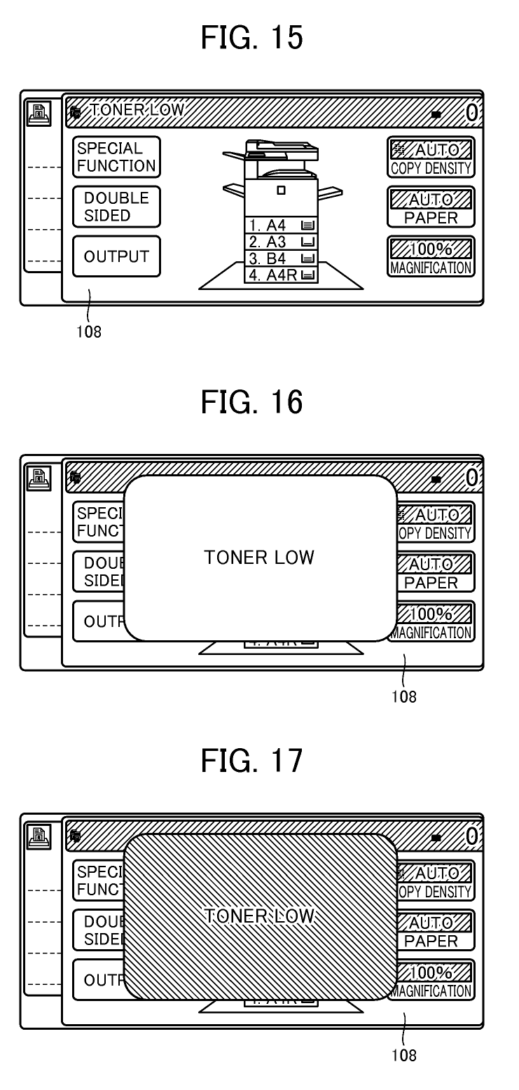

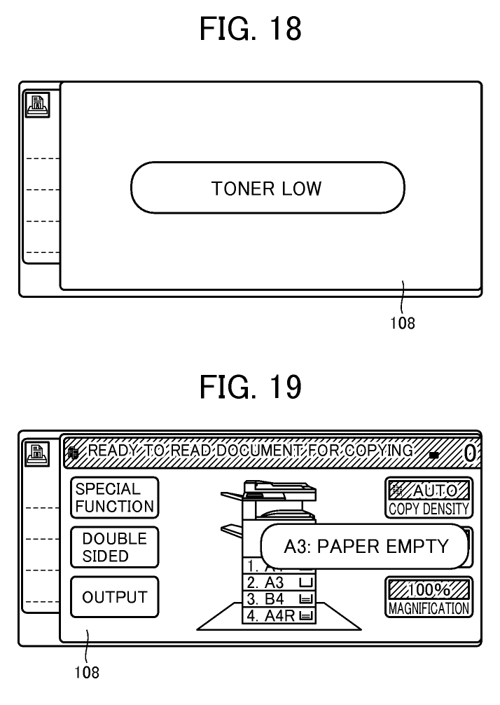

By way of example, as shown in FIGS. 15 to 19, when error information of image forming apparatus 20 is to be displayed on electronic paper 108, the error information of image forming apparatus 20 may be displayed in enhanced manner to better appeal to the user. Then, it is possible for the user to understand, by simply taking one look at the contents displayed on electronic paper 108, which type of error occurred in the apparatus. FIG. 15 is an example in which the message “TONER LOW” is displayed larger than in FIG. 8 and in highlight. FIG. 16 shows an example in which the message “TONER LOW” is displayed in enlargement, overlapped on the standard image of FIG. 6. FIG. 17 shows an example in which the message “TONER LOW” is displayed in enlargement and in highlight, overlapped on the standard image of FIG. 6. FIG. 18 shows an example in which the message “TONER LOW” is displayed in enlargement, while other displays are turned off. FIG. 19 shows an example in which the message of “PAPER EMPTY” of FIG. 7 is displayed in enlargement.

Further, when a plurality of errors are detected, pieces of error information may be displayed successively on electronic paper 108, starting from the one having the highest priority. Then, it is possible for the user and the service person to check the errors of the apparatus starting from the one having higher priority.

In addition, display of error information of image forming apparatus 20 on electronic paper 108 may be continued even after power supply is resumed. Then, error information continuously displayed on electronic paper 108 when power conduction is resumed provides good support for the user and the service person.

Various other design changes and modifications may be made within the scope of claims as appended to the present specification.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An image forming apparatus, comprising:
a first display unit displaying a state of the apparatus during the time of power conduction;
a second display unit maintaining displayed contents during the time of non-power-conduction;
an error detection unit detecting an error state of the apparatus; and
an error display control circuit causing, when an error of the apparatus is detected by said error detection unit and power conduction to the apparatus is shut off with the error not rectified, said second display unit to display error information of the apparatus indicating occurrence of the error in the apparatus.

2. The image forming apparatus according to claim 1, wherein
said second display unit is a non-volatile display device.

3. The image forming apparatus according to claim 1, wherein
said second display unit also serves as said first display unit.

4. The image forming apparatus according to claim 1, wherein
said error display control circuit causes said second display unit to display, as said error information of the apparatus, information indicating occurrence of paper jam.

5. The image forming apparatus according to claim 1, wherein
said error display control circuit causes said second display unit to display, as said error information of the apparatus, information indicating shortage of supplies related to image formation.

6. The image forming apparatus according to claim 1, wherein
said error display control circuit causes said second display unit to display, as said error information of the apparatus, information urging contact with a service person.

7. The image forming apparatus according to claim 1, wherein
said error display control circuit causes said second display unit to display, as said error information of the apparatus, information urging contact with a service person, indicating either occurrence of a trouble in the apparatus or end of life of a consumable part.

8. The image forming apparatus according to claim 1, wherein
said error display control circuit includes a display control circuit causing, when said error information of the apparatus is displayed on said second display unit, display of information to avoid the error of the apparatus, in addition to the error information of the apparatus.

9. The image forming apparatus according to claim 1, wherein
said error display control circuit includes a display control circuit causing, when said error information of the apparatus is displayed on said second display unit, said error information of the apparatus to be displayed in an enhanced manner that better appeals to the user.

10. The image forming apparatus according to claim 1, wherein
said error display control circuit includes a display control circuit causing said second display unit to display, when a plurality of errors are detected by said error detection unit, pieces of said error information of the apparatus successively, starting from one having highest priority.

11. The image forming apparatus according to any of claims 1 to 10, wherein
said error display control circuit includes a display control circuit causing said second display unit to continue display of said error information of the apparatus even after power conduction to the apparatus is resumed.
